(19) United States
(12) Patent Application Publication
(10) Pub. No.: US 2015/0286640 A1
(43) Pub. Date: Oct. 8, 2015

(54) DATA STORAGE DEVICE, DATA STORAGE METHOD AND PROGRAM

(71) Applicant: NEC CORPORATION, Tokyo (JP)

(72) Inventor: Takashi Horikawa, Tokyo (JP)

(73) Assignee: NEC Corporation, Tokyo (JP)

(21) Appl. No.: 14/438,274

(22) PCT Filed: Oct. 21, 2013
(86) PCT No.: PCT/JP2013/006199

§ 371 Date: Apr. 24, 2015

(30) Foreign Application Priority Data
Oct. 24, 2012 (JP) 2012-234776

(51) Int. Cl. G06F 17/30

(52) U.S. Cl. CPC G06F 17/3033

(57) ABSTRACT

A data storage device includes: a storing unit which stores means for storing a counter associated with each hash entry in a hash table; a first executing unit which means for, when receiving an execution command for a process, increments or decrements incrementing or decrementing a value of the counter which is associated with the hash entry according to an operation for the hash entry, the operation being included in the process; and a second executing unit which means for, when receiving an execution command for a process including an deletion operation for the hash entry, executes executing the deletion operation for the hash entry according to the value of the counter which is associated with the hash entry.

### TECHNICAL FIELD

The present invention relates to a data storage technology in a multi-processor system, in particular a data storage technology storing data by a method in which manipulations of search, insertion, and deletion are executable in parallel.

### BACKGROUND ART

In a computer system, in order to effectively use computer resources, like a processor, it is common to operate a plurality of processes or threads in parallel. Strictly speaking, processes and threads are not perfectly identical. However, they are similar concept from the point of view of units executing a program. Therefore, since as far as the object of explaining the present invention is concerned, the difference of the two is not required to be distinguished, a unit of executing a program is written as a thread in this description.

In an information system configured to simultaneously execute a plurality of threads in parallel using a plurality of processors, a plurality of threads can access, in parallel, data which exists in memory. If the data which each of the threads access is separated, it will be not a problem even though the plurality of threads access the memory in parallel. However, when the plurality of threads access related data or the same data without being aware of other threads, an execution result which is different from that in a case when a single thread accesses data may be caused and a problem may occur.

For example, a process is considered, in which an element is inserted to data having a list structure in which a plurality of elements are connected by a pointer. FIG. 12A illustrates an example of data of a list structure in which elements A and B are connected. In this example, an operation, by one thread, in which an element N is inserted between the elements A and B is executed by setting a value indicating the element N to the pointer of A after copying a pointer value of the element A, which is pointing the element B, to a pointer of the element N.

An operation is considered, in which two threads simultaneously execute an operation in which elements N1 and N2 are inserted in the same position, that is, in the position between elements A and B. The thread which inserts the element N1 (1) copies the pointer value of the element A in the pointer of the element N1, and, after that, (2) sets the value indicating the element N1 to the pointer of the element A. The thread which inserts the element N2 (3) copies the pointer value of the element A in the pointer of the element N2, and, after that, (4) sets the value indicating the element N2 to the pointer of the element A. If operations (1) to (4) are conducted in order of (1), (2), (3) and (4), or in order of (3), (4), (1) and (2), the right execution result, that is, a state in which the elements N1 and N2 is inserted in the list is made.

However, if the operations of the two threads are alternately conducted, for example, in order of (1), (3), (2) and (4), a wrong execution result is caused as shown in FIG. 12C. The simplest method of avoiding occurrence of such wrong operation series is a method using a critical section based on an exclusive control mechanism, for example, a lock. When executing an operation series, for example, the operation series of (1) and (2) and the operation series of (3) and (4), whose execution result becomes wrong if an operation by a different thread is performed while the operation series is executed, it is avoided that an operation by a different thread intrudes itself into the operation series executed in the critical section by acquiring a lock and entering the critical section first, executing a required operation next, and releasing the lock after completion of the operation and going out of the critical section.

However, in the method using the critical section, there is a problem that, as the number of processors is increased, disadvantage of performance is increased. A method is devised, in which access from a plurality of threads is consistently performed by using a command for a multiprocessor included in a processor, without forming the critical section. A typical example of the command for the multiprocessor used here is the cmpxchg command of Intel x86 processors described in Non-Patent Literature NPL 1. It is a command using three operands including a register reserved by a command (eax register in 32 bits data), a register operand and a memory operand, and performs, in an atomic manner, a series of operations including (1) loading a value of the memory operand into a processor, (2-1) writing, when the value is consistent with a value of the eax register, a value of the register operand into memory, and (2-2) writing, when the value is not consistent with the value of the eax register, the value into the eax register. “Atomic” described above means that a hardware operation guarantees that another processor does not access the memory while (1) the memory loading operation and (2-1) the memory writing operation. The operation carried out by the cmpxchg command is frequently called Compare And Swap (i.e. CAS operation).

An algorithm is devised, in which a right execution result is obtained by using the CAS operation, even though a plurality of threads simultaneously performs accesses to list structure data (i.e. insertion and deletion of elements in the list structure data, and search of the list structure data). An example thereof is shown in Non-Patent Literature NPL 2. The characteristics are that (1) a target of the CAS operation is pointer type data storing link information for the list structure, and (2) several low-order bits which are normally fixed to zero in the pointer type data is used as flag information. A particularly important item in the flag information is a mark bit which indicates that the link information is not changed and entry thereof is logically deleted.

In this algorithm, if the CAS operation is not failed, element insertion into the list structure data is performed by one search process for an insertion position and one CAS operation. Element deletion in the list structure data is performed by one process of searching a position of a deletion target element in the list structure data, one CAS operation of setting a mark bit to the pointer data in the deletion target element, i.e. logically deleting the element, and one CAS operation of changing pointer information of an element located before the deletion target element and removing the deletion target element from the list structure, i.e. physically deleting the element.

Non-Patent Literature NPL 2 further discloses a plurality of above-described list structures and a hash table which includes an array storing pointers to the list structures. The hash table stores data of a search target (hereinafter referred to as “hash entry”) according to a method with which high-speed search operation can be carried out and which enables an insertion and deletion operation of the hash entry in addition to a search operation. Regarding the hash table described in Non-Patent Literature 2, because (1) possible accesses are search, insertion and deletion operations of the hash entry, (2) these accesses can be carried out without using the critical section (hereinafter referred to as “lock free”), a plurality of threads can simultaneously access the hash table in parallel. In other words, there is the hash table in which the plurality of threads can simultaneously perform the search operation, the insert operation and the deletion operation in parallel. There also exists a hash table for which the provided as a basic operation is a search and insert operation in which the search operation and the insert operation are mixed, instead of the search operation and the insert operation. In the search and insert operation, the search operation is performed first, and when, as a result thereof, search target entry does not exist, a new hash entry is formed and inserted into the hash table.

### CITATION LIST

### Non Patent Literature

[NPL 1] “IntelR 64 and IA-32 Architectures Software Developer's Manual Volume 2A: Instruction Set Reference, A-L”, [online], Intel, internet(URL: http://www.intel.com/Assets/PDF/manual/253666.pdf)
[NPL 2] Maged M Michael, “High Performance Dynamic Lock-Free Hash Tables and List-Based Sets”, ACM SPAA' 02

### SUMMARY OF INVENTION

### Technical Problem

A problem is that, when a first thread searches a lock free hash table to acquire a hash entry first, and performs a process using the hash entry next, if a second thread deletes the hash entry between the search and the process, there is a possibility that the process by the first thread cannot be normally performed.

The reason is that, if the second thread deletes the hash entry between the search and the process performed by the first thread, the hash entry is already deleted when the first thread performs the process using the hash entry.

A main object of the present invention is to provide a technology to normally execute a plurality of processes on the hash table.

### Solution to Problem

A data storage device of the present invention includes: storing means for storing a counter associated with each hash entry in a hash table; first executing means for, when receiving an execution command for a process, incrementing or decrementing a value of the counter which is associated with the hash entry according to an operation for the hash entry, the operation being included in the process; and second executing means for, when receiving an execution command for a process including an deletion operation for the hash entry, executing the deletion operation for the hash entry according to the value of the counter which is associated with the hash entry.

A data storage method of the present invention is executed in a device including a processor and storing means for storing a counter associated with each hash entry in a hash table, and the method includes: a first execution step of, when the processor receives an execution command for a process, incrementing or decrementing a value of the counter which is associated with to the hash entry according to an operation of the hash entry, the operation being included in the process; and a second execution step of, when the processor receives an execution command for a process including an deletion operation for the hash entry, executing the deletion operation for the hash entry according to the value of the counter which is associated with the hash entry.

A program of the present invention causes a computer to function as: storing means for storing a counter associated with each hash entry in a hash table; first executing means for, when an execution command for a process is received, incrementing or decrementing a value of the counter which is associated with the hash entry according to an operation for the hash entry, the operation being included in the process; and second executing means for, when an execution command for a process including an deletion operation for the hash entry is received, executing the deletion operation for the hash entry according to the value of the counter which is associated with the hash entry.

The present invention is realized by using a computer-readable non-transitory storage medium in which the program is stored.

### Advantageous Effects of Invention

According to the present invention, the technology to normally execute a plurality of processes on the hash table can be provided.

### BRIEF DESCRIPTION OF DRAWINGS

FIG. 1 is a block diagram showing a structure of a system in one exemplary embodiment of the present invention,

FIG. 2 is a diagram showing a structure of a list structure and a hash entry which is an element of the list which are used in one exemplary embodiment of the present invention,

FIG. 3 is a diagram illustrating an atomic operation which is used in one exemplary embodiment of the present invention,

FIG. 4 is a flowchart showing a positioning operation common to all operations in a hash table in one exemplary embodiment of the present invention,

FIG. 5 is a flowchart showing an operation of a search and insert operation on the hash table in one exemplary embodiment of the present invention,

FIG. 6 is a flowchart showing an operation of a reference deletion operation on the hash table in one exemplary embodiment of the present invention,

FIG. 7 is a flowchart showing an operation which an application performs on the hash entry in one exemplary embodiment of the present invention,

FIG. 8 is block diagram showing a structure of a system in another exemplary embodiment of the present invention,

FIG. 9 is a flowchart showing of an operation of a search and insert operation on the hash table in another exemplary embodiment of the present invention,

FIG. 10 is a flowchart showing an operation of a reference deletion operation on the hash table in another exemplary embodiment of the present invention,

FIG. 11 is a flowchart showing an operation of a deletion operation on the hash table in another exemplary embodiment of the present invention,

FIG. 12A is a diagram showing list structure data,

FIG. 12B is a diagram representing insert operation of an element in the list structure data,

FIG. 12C is a diagram representing a situation in which two threads simultaneously perform the insert operation in parallel.

### DESCRIPTION OF EMBODIMENTS

An exemplary embodiment of the present invention is described in detail with reference to drawings.

### First Exemplary Embodiment

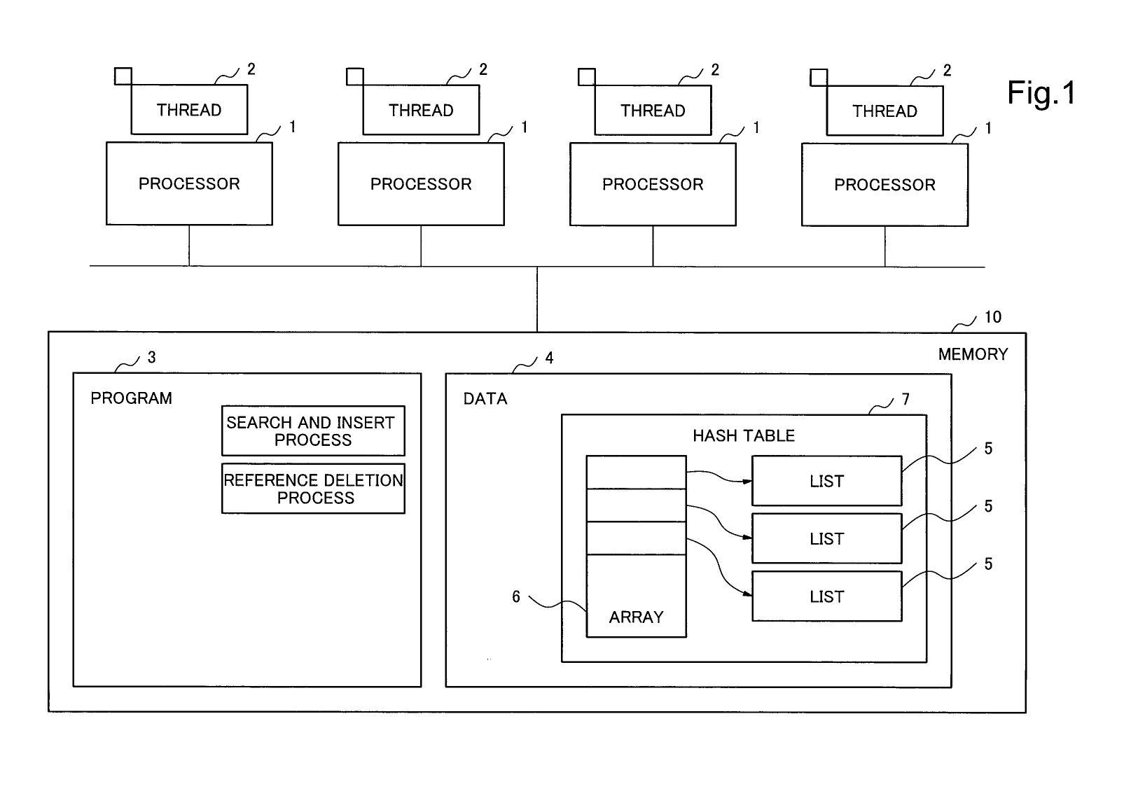

With reference to FIG. 1, a structure of a system (a device storing data) in an exemplary embodiment of the present invention is described. The system includes a plurality of processors 1 executing threads 2, and a memory 10.

The memory 10 stores a program 3 executed on the thread 2 by the processor 1 and data 7 which is used when the thread 2 executes the program 3. The program 3 includes a search and insert process and a reference deletion process. The data 4 includes a hash table 7 made with a plurality of lists 5 and an array 6 storing pointers to the lists 5.

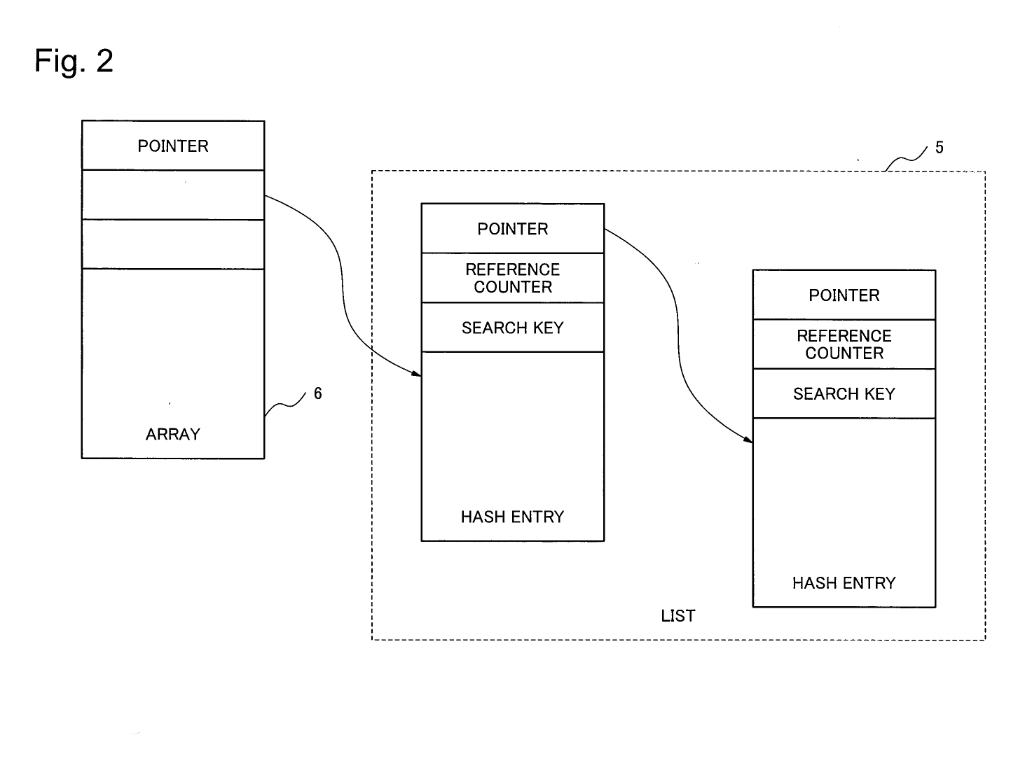

With reference to FIG. 2, the data 4 stored in the memory 10 is described. The list 5 has a structure in which a hash entry is linked with a pointer. Each hash entry includes the pointer pointing a hash entry which is a linked destination, a reference counter, and a search key. Each element in the array is the pointer pointing the hash entry which is a top element of the list 5. When the pointer in the hash entry and the pointer which is each element of the array are NULL value, the pointers are showing that the hash entry to be linked ahead does not exist. Further, in the pointer in the hash entry, as described in Non-Patent Literature NPL 2, a low-order bit which is normally fixed to zero is used as flag information. In the exemplary embodiment, the lowest single bit is used as a mark bit indicating that the entry is logically deleted.

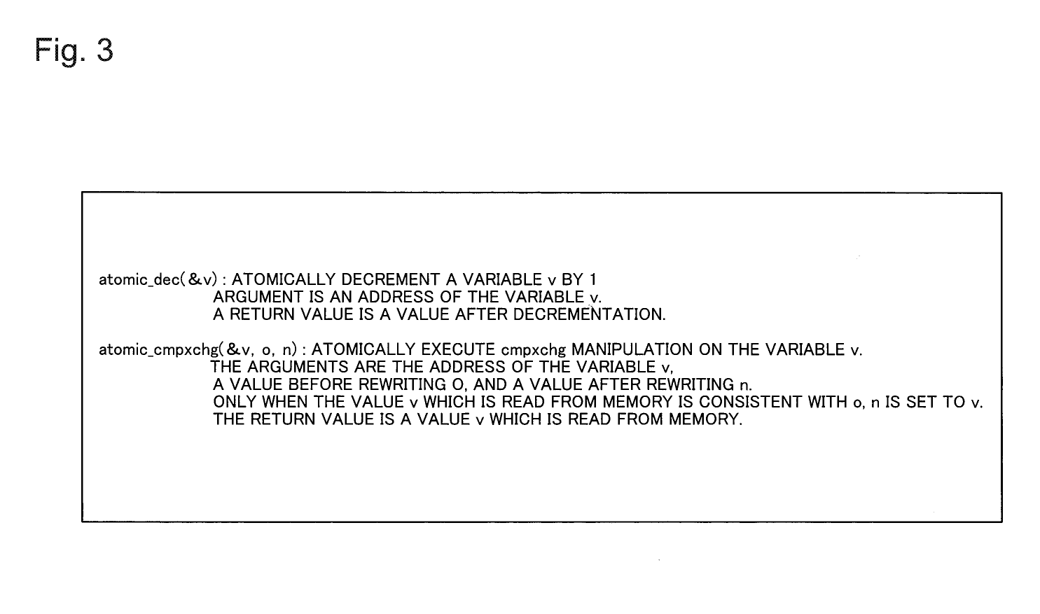

FIG. 3 shows, as a basic operation used in the present exemplary embodiment, “atomic_dec(&v)” which is an operation of atomically subtracting a value one with respect to a variable v, and “atomic_cmpxchg(&v, o, n)” which is an operation of atomically executing “cmpxchg” operation of changing a value zero into a value n with respect to the variable v.

Next, a whole operation of the present exemplary embodiment, in particular a part different from Non-Patent Literature 2 is mainly described.

It is assumed that an access to the hash table 7 (i.e. a search and insert operation and a reference deletion operation of the hash entry) is activated by the program 3 executing the access by giving search key (key). The key is data by which comparison in size is possible. A basic process flow of the search and insert operation and the reference deletion operation is executed according to the process flow described in Non-Patent Literature NPL 2.

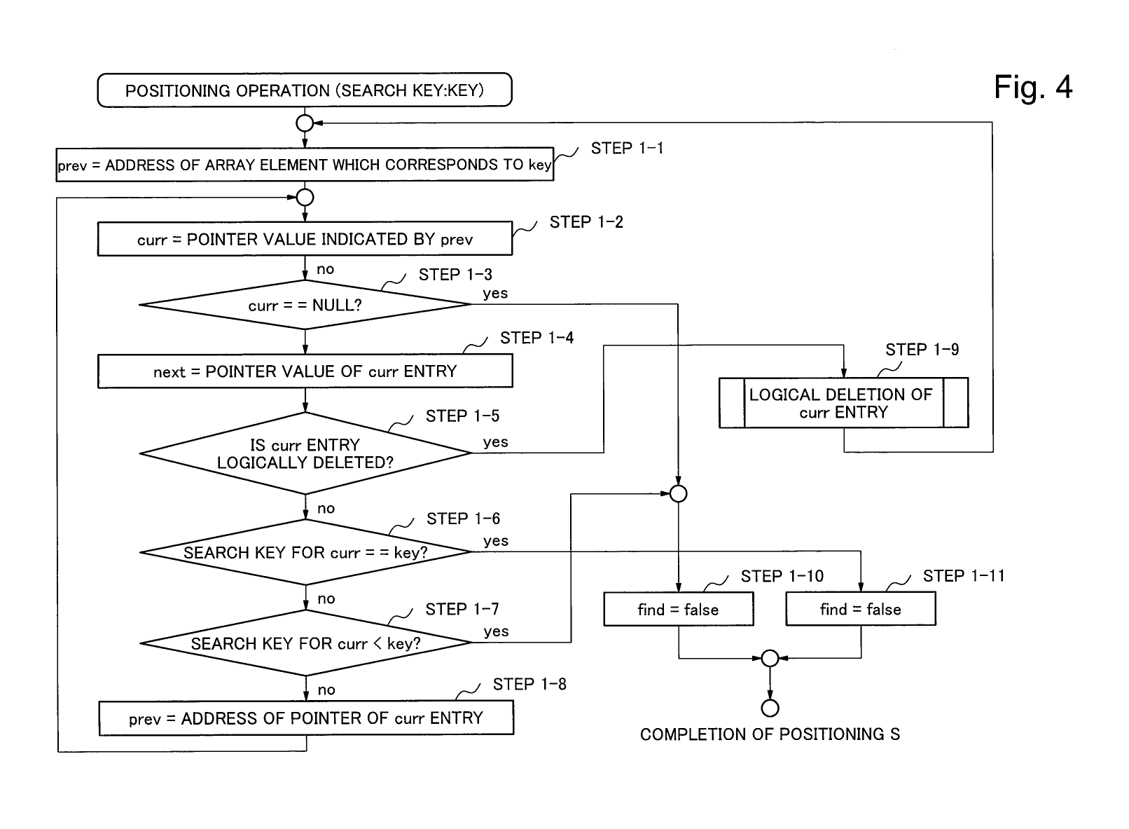

With reference to a flowchart shown in FIG. 4, a processing of a positioning operation which is common in all operations on the hash table 7 of the present exemplary embodiment is described. As described above, the operations are executed by the processor 1 included in the system (device) shown in FIG. 1.

An argument which is given when the positioning operation is activated is a search key (key). As the result of the positioning operation, a hash entry is stored in “curr”, an address storing a pointer to the “curr” is stored in “prev”, and a flag indicating whether or not a hash entry which corresponds to the key is found is stored in “find”. As a pointer variable for working, “next” is used.

When the search key (key) is given and the positioning operation is activated, an address of an array element which is uniquely fixed by a key value, similarly to the hash table 7, is acquired and stored in the prev which is the pointer variable (STEP 1-1).

Next, a pointer to the hash entry is read from the address indicated by the prev pointer, and stored in the “curr” variable (STEP 1-2). Next, whether or not the “curr” variable is NULL is examined (STEP 1-3). When being NULL, a “find” flag is set to “false” (STEP 1-10) and the positioning operation is finished.

When not being NULL, a pointer in a hash entry pointed by the “curr” pointer (hereinafter referred to as curr entry) is set to the “next” variable (STEP 1-4). Next, the lowest single bit (mark bit) of the “next” pointer is examined, and whether or not the “curr” entry is logically deleted is examined (STEP 1-5). As a result, when the “curr” entry is logically deleted, the “curr” entry is physically deleted (STEP 1-9) and redoing from the first STEP 1-1 is carried out.

When, in STEP 1-5, it is determined that the “curr” entry is not logically deleted, the search key of the “curr” is compared with the key which is given for the positioning operation (STEP 1-6 and STEP 1-7). As a result of the comparison, the keys are consistent with each other, the “find” flag is set to “true” (STEP 1-11) and the positioning operation is finished. As a result of the comparison, the search key of the “curr” is smaller than the given key, the “find” flag is set to “false” (STEP 1-10), and the positioning operation is finished. When a size relation of both of the keys is other than the above descriptions (i.e. search key of the “curr” is larger than the given key), an address in which a pointer is stored in the “curr” entry is set to a “prev” pointer variable (STEP 1-8) and return to STEP 1-2 is performed.

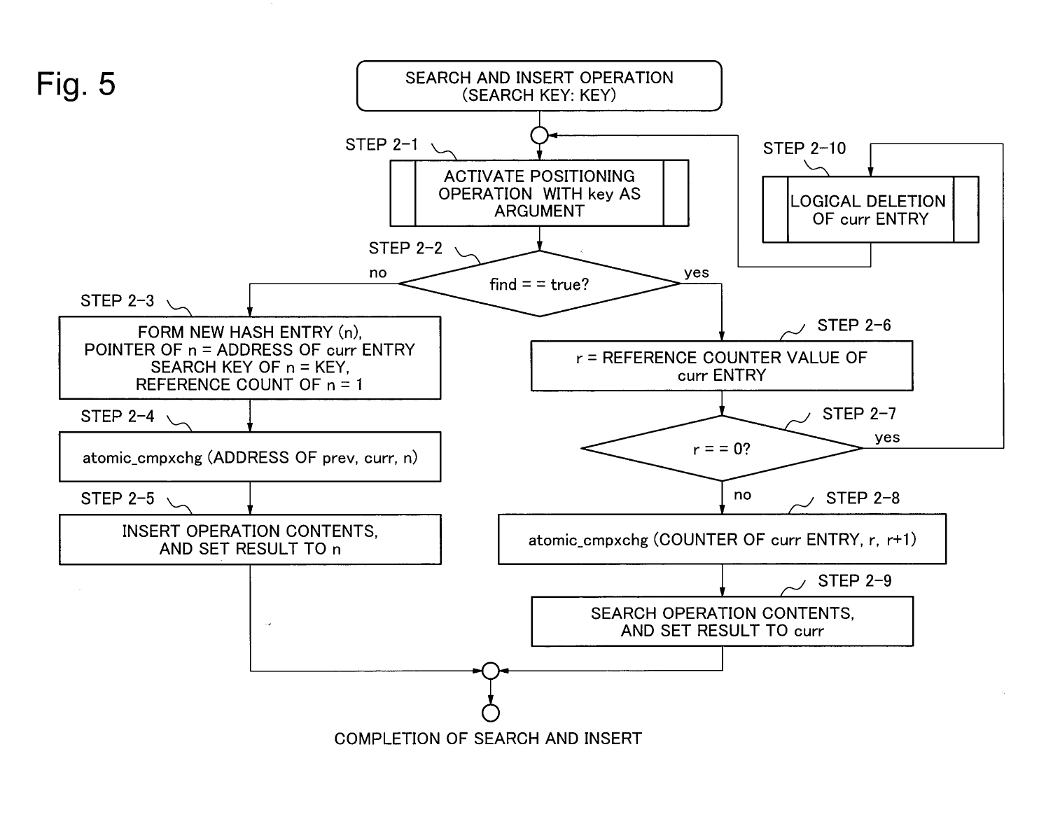

Next, with reference to a flowchart of FIG. 5, the search and insert operation on the hash table in the present exemplary embodiment is explained. As described above, the operation is executed by the processor 1 included in the system (device) shown in FIG. 1.

The argument which is given when the search and insert operation is activated is the search key (key), and the results of the search and insert operation are (1) information identifying whether the executed operation content is search or insertion and (2) the pointer to the hash entry storing the search key which is consistent with the key on the hash table 7.

In the search and insert operation, the positioning operation which is explained with reference to FIG. 4 is activated using the key as an argument (STEP 2-1), the “find” flag, the “prev”, and the “curr” pointer are received as the execution result.

Next, a value of the “find” flag is examined (STEP 2-2), and when it is determined to be “true”, a variable r is set to a value of the reference counter in the “curr” entry (STEP 2-6), and whether or not the value of r is zero is examined (STEP 2-7). When the value of r is estimated to be zero, this result means that the entry is not able to be used, the search operation which starts from the positioning operation fails, a logical deletion operation of the “curr” entry is executed (STEP 2-10), and return to STEP 2-1 is performed. When the value of r is estimated not to be zero, an “atomic cmpxchng” operation which changes the value of the reference counter in the “curr” entry from r to r+1 is executed (STEP 2-8). In STEPs 2-7, 2-8, and 2-10 of the search and insert operation, when the value of the reference counter in the “curr” entry is zero (or a specific value), the logical deletion operation of the “curr” entry is carried out, and when the value of the reference counter in the “curr” entry is not zero (or the specific value), the value of the reference counter in the “curr” entry is incremented by one.

When the “atomic cmpxchng” operation succeeds, as the result of the search and insert operation, executed operation contents are searched, the pointer to the hash entry which is the execution result is set to “curr” (STEP 2-9), and the search and insert operation is completed. When the “cmpxchg” operation of STEP 2-8 fails (not shown in FIG. 5), return to STEP 2-6 is performed.

In STEP 2-2, when the value of the “find” flag is estimated to be “false”, a new hash entry (n) is created. An address of the “curr” entry is set to a pointer of the formed hash entry is set to an address of the “curr” entry, the search key is set to the key, and the reference counter is set to 1 (STEP 2-3). The “cmpxchg” operation is executed, in which a pointer which is stored at a position of the “prev” pointer is rewritten from the “curr” to an address of the new entry (n) (STEP 2-4).

If the “atomic cmpxchg” operation succeeds, as a result of the search and insert operation, the executed operation contents are inserted, a pointer to the hash entry which is an execution result is set to the address of the new entry (STEP 2-5), and the search and insert operation is completed. If the “cmpxchg” operation of STEP 2-4 fails (not shown in FIG. 5), the new entry is deleted, and return to STEP 2-1 is performed.

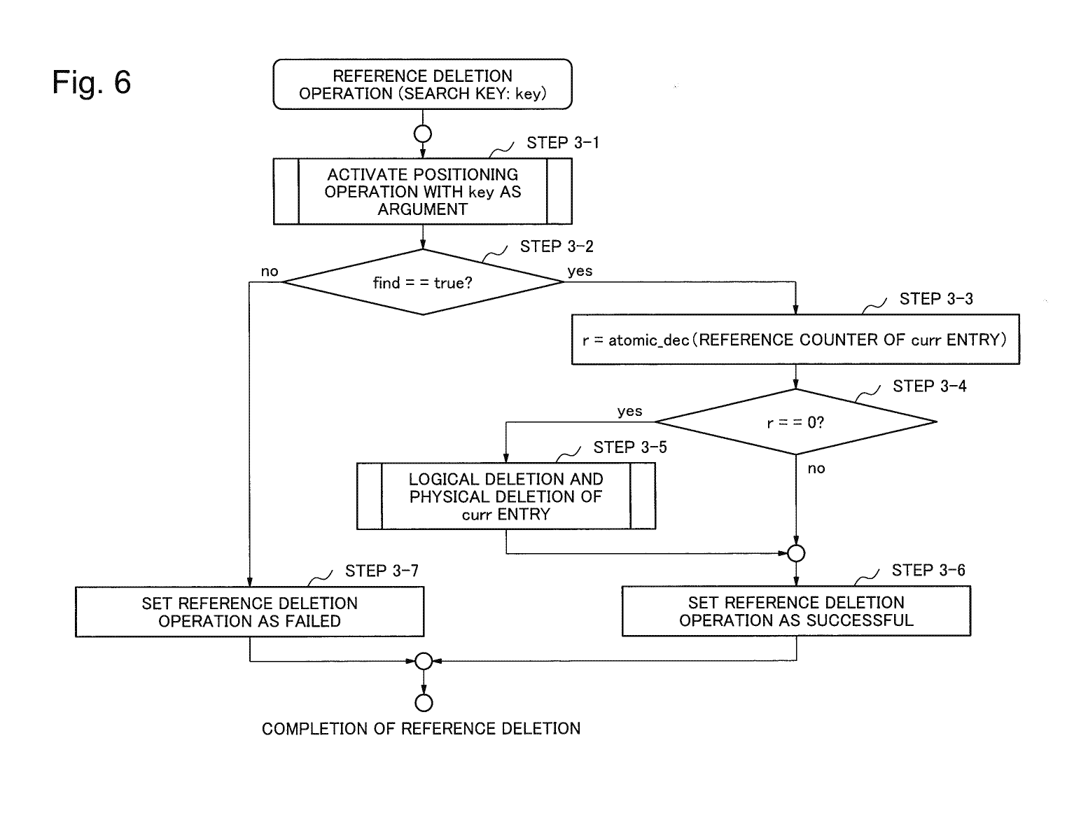

Next, with reference to a flowchart in FIG. 6, processing of a reference deletion operation on the hash table according to the present exemplary embodiment is explained. As described above, the operation is executed by a processor included in the system (device) shown in FIG. 1. An argument which is given when the reference deletion operation is activated is the search key (key), and a result of the reference deletion operation is a flag indicating whether or not the reference deletion operation succeeds.

In the reference deletion operation, the key is an argument, the positioning operation which is explained with reference to FIG. 4 is activated (STEP 3-1), and, as an execution result, the “find” flag, and the “prev” and the “curr” pointers are received.

Next, a value of the “find” flag is examined (STEP 3-2), when the value is estimated to be “true”, a “atomic dec” operation is executed to the reference counter of the “curr” entry, and the value after subtraction is stored in r (STEP 3-3). In STEP 3-3 of the reference deletion operation, a value of the reference counter of the “curr” entry is decremented by 1.

Next, whether or not the value of r is zero is examined (STEP 3-4). As a result, the value of r is estimated not to be zero, the reference deletion operation is set as successful (STEP 3-6) and the reference deletion operation is finished. In STEP 3-4, when the value of r is estimated to be zero, the logical deletion and the physical deletion operation of the “curr” entry are executed (STEP 3-5), and transfer to STEP 3-6 is performed. In STEPs 3-4, 3-5, and 3-6 of the reference deletion operation, when the value of the reference counter of the “curr” entry is zero (or a specific value), operations of logical deletion and physical deletion of the “curr” entry are executed, and when the value of the reference counter is not zero (or the specific value), deletion operations of the “curr” entry are not executed.

In STEP 3-2, when the value of the “find” flag is estimated to be “false”, the reference deletion operation is set as failed (STEP 3-7), and the reference deletion operation is finished.

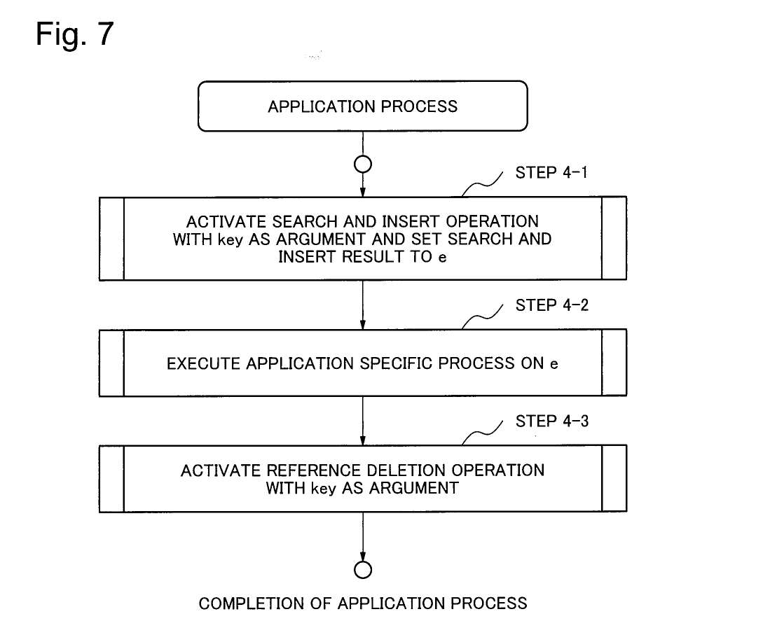

With reference to a flowchart of FIG. 7, operations are explained, in which an application performs operations on a hash entry having the search key. A first STEP of such application process is to activate the search and insert operation with the key as an argument (STEP 4-1). A process specific to the application is executed on a hash entry e, which is obtained as an execution result of the search and insert process (STEP 4-2), and finally the reference deletion operation is activated with the key as an argument. Since a reference counter of the hash entry e becomes zero owning to the reference deletion operation when other threads do not use the hash entry e, the hash entry e is deleted from the hash table. When a plurality of threads 2 access the hash entry e in parallel according to the process shown in FIG. 7, since the reference counter of the hash entry e becomes zero owning to the reference deletion operation which is finally activated, the hash entry e is deleted from the hash table 7 by the thread 2 which activates the reference deletion operation.

In a case where the plurality of threads 2 access the hash entry e in parallel, when, after a thread 2 (first thread) sets the reference counter to zero and before the thread 2 refers to the reference counter, another thread 2 (second thread) refers to the reference counter, the second thread 2 deletes the hash entry e from the hash table 7. In other words, When an execution command of the thread 2 (process) including the deletion operation of the hash entry is received at a specific timing, the thread 2 (process) which sets the reference counter to zero is different from the thread 2 (process) which deletes the hash entry e from the hash table.

As above, in the present exemplary embodiment, the plurality of threads 2 (process) access the same hash entry on the hash table 7 (e.g. hash entry e). When receiving an execution command of a thread 2 (process), the processor 1 increments or decrements a value of the reference counter of the hash entry e according to the operation of the hash entry e included in the thread 2. When receiving an execution command of another thread including a deletion operation of the hash entry e, the processor 1 executes the deletion operation of the hash entry e according to a value of the reference counter of the hash entry e (only when specific value (e.g. zero)). As a result, a plurality of processes on the hash table 7 can be normally executed without using the critical section.

### Second Exemplary Embodiment

In the present exemplary embodiment, an operation on a hash entry of the hash table 7 is described, in which −1 is a specific value in a reference counter. When each of the threads 2 executes a search and insert operation and a reference deletion process in pairs, a value of the reference counter is always zero or more. Therefore, in the present exemplary embodiment, an operation of deleting the hash entry from the hash table 7 is provided independently of the search and insert operation and the reference deletion process.

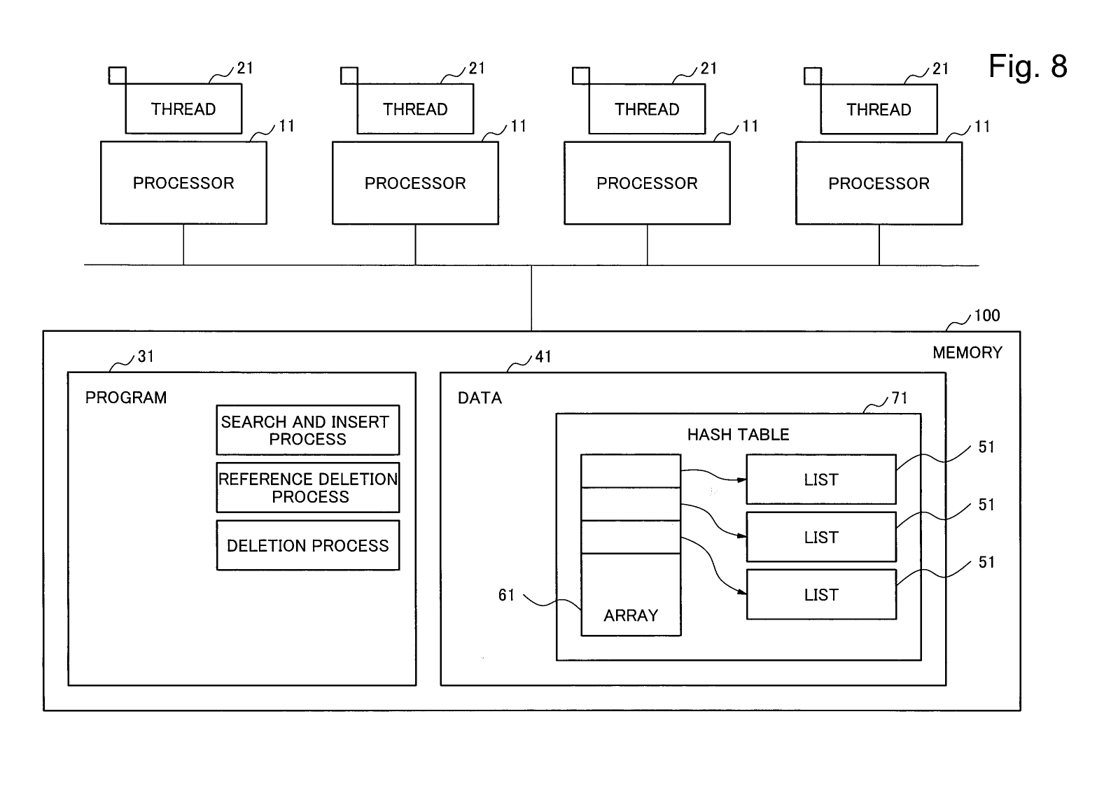

FIG. 8 illustrates an example of a structure of a system (data storing device) in the present exemplary embodiment. In this example, a program 31 includes a deletion process in addition to the search and insertion process and the reference deletion process. The other parts are the same as those of the first exemplary embodiment. In the present exemplary embodiment, the following are similar to those of the first exemplary embodiment: as a list 51 and an atomic memory access operation, those shown in FIG. 2 and FIG. 3, respectively, which are similar to those of the first exemplary embodiment, are used; access to a hash table 71 is given a search key (key) and is activated by a program 31 performing the access; the key is data by which comparison in size is possible; and the positioning operation shown in the flowchart in FIG. 4 is used as a positioning operation common to all operations in a hash table in the present exemplary embodiment.

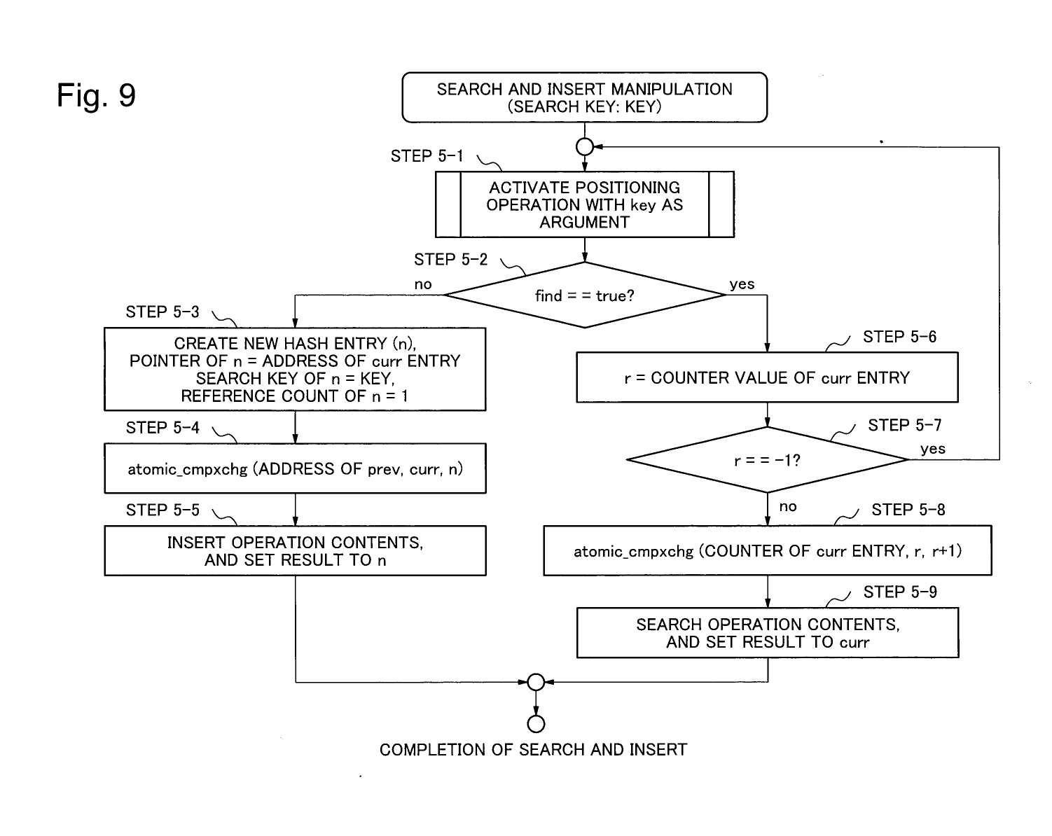

With reference to a flowchart in FIG. 9, an operation of a search and insert operation on the hash table 71 in the present exemplary embodiment is explained. An argument which is given when the search and insert operation is activated is the search key (key). The results of the search and insert operation are (1) information identifying whether executed operation contents are search or insertion, and (2) a pointer to a hash entry in which the search key which is consistent with the key is stored on the hash table 71.

In the search and insert operation, the positioning operation is activated with the key as an argument (STEP 5-1), and as the execution result, a “find” flag, “prev”, and “curr” pointers are received. Next, a value of the “find” flag is examined (STEP 5-2), and when the value is estimated to be “true”, a variable r is set to a value of a reference counter in a “curr” entry (STEP 5-6) and whether or not the value of r is −1 is examined (STEP 5-7).

As a result, when the value of r is −1, since the hash entry is deleted halfway by a deletion operation described below, the search operation which starts from the positioning operation fails and the process flow is returned to STEP 5-1. A process of waiting for a given period of time while returning from STEP 5-7 to STEP 5-1 may be included.

When the value of r is not −1, an “atomic cmpxchg” operation is executed, in which the value of the reference counter in the “curr” entry is changed from r to r+1 (STEP 5-8). When the “atomic cmpxchg” operation succeeds, as the result of the search and insert operation, the executed operation contents are searched, the pointer to the hash entry, which is the execution result, is set to the “curr” (STEP 5-9), and the search and insert operation is finished. When the “atomic cmpxchg” operation of STEP 5-8 fails (not shown in FIG. 9), return to STEP 5-6 is performed. When the result of examination of the “find” flag in STEP 5-2 is “false”, the operation is the same as that of the first exemplary embodiment.

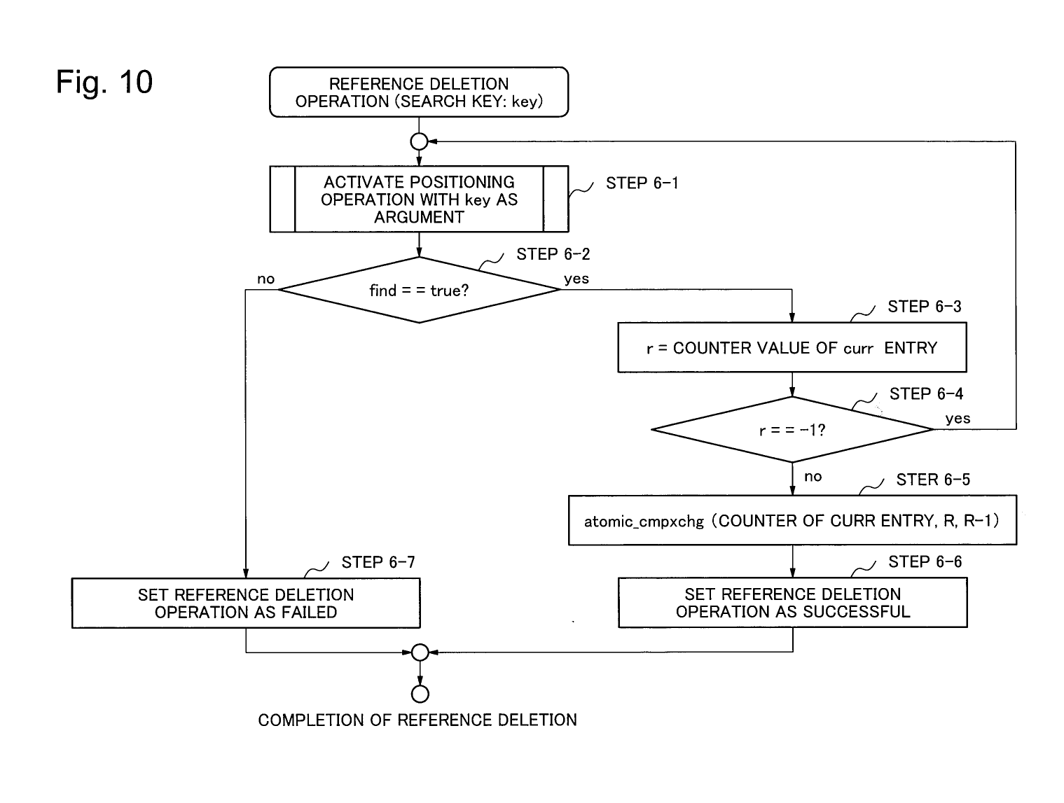

Next, with reference to a flowchart of FIG. 10, an operation of a reference deletion operation on the hash table 71 in the present exemplary embodiment is described. An argument which is given when the reference deletion operation is activated is the search key (key). A result of the reference deletion operation is a flag indicating whether or not the reference deletion operation succeeds.

In the search and insert operation, the positioning operation explained with reference to FIG. 4 is activated with the key as an argument (STEP 6-1), and as the execution result, the “find” flag, the “prev” and the “curr” pointers are received. Next, a value of the “find” flag is examined (STEP 6-2), and when the value is estimated to be “true”, a variable r is set to a value of the reference counter in the “curr” entry (STEP 6-3), and whether or not the value is −1 is examined (STEP 6-4).

As a result, when the value of r is −1, return to STEP 6-1. A process of waiting for a predetermined period of time while returning from STEP 6-4 to STEP 6-1 may be included. When the value of r is not −1, the “atomic cmpxchg” operation is executed, in which the value of the reference counter in the “curr” entry is changed from r to r−1 (STEP 6-5). In other words, in the reference deletion operation including a deletion operation, when the value of the reference counter is a specific value, the value of the reference counter is decremented.

If the “atomic cmpxchg” operation succeeds, the reference deletion operation is set as successful (STEP 6-6) and the reference deletion operation is finished. When the “cmpxchg” operation of STEP 6-5 fails (not shown in FIG. 10), return to STEP 6-3 is performed. When the “find” flag becomes “false” in STEP 6-2, the reference deletion operation is set as failed (STEP 6-7) and the reference deletion operation is finished.

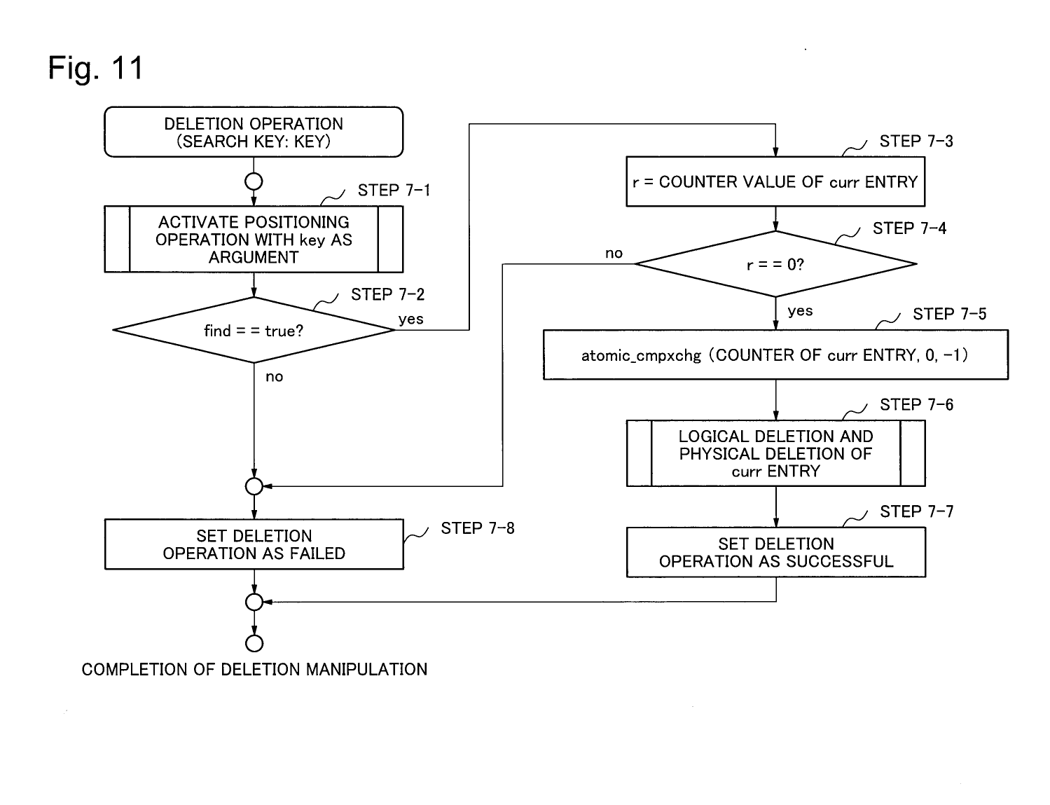

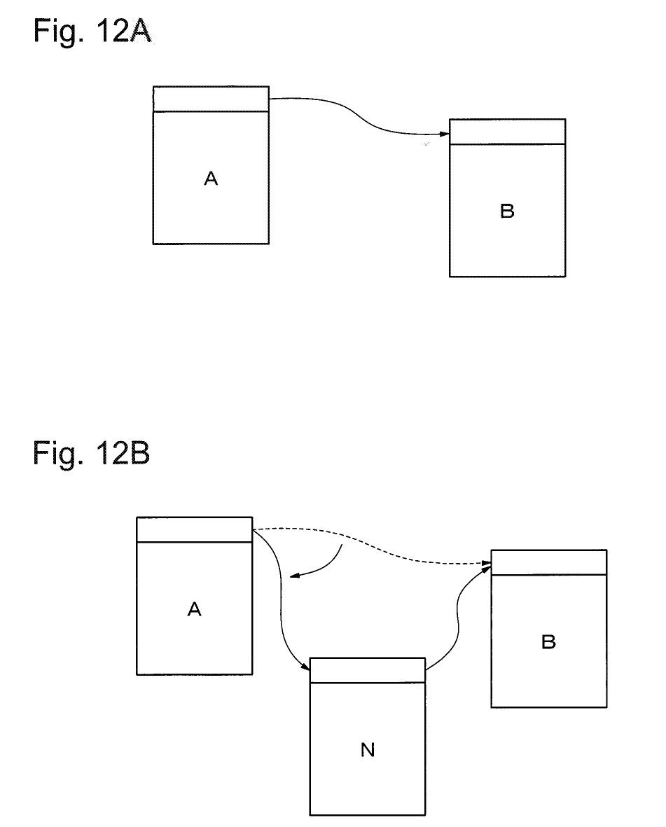

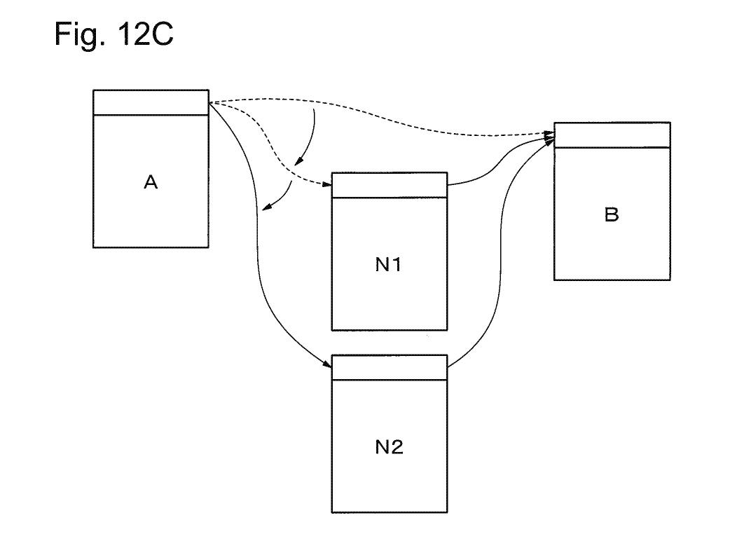

Next, with reference to a flowchart of FIG. 11, an operation of a deletion operation on the hash table 71 of the present exemplary embodiment is described. The operation is executed in a thread 21 by a processor 11 included in the system (device) shown in FIG. 8. An argument which is given when the deletion operation is activated is the search key (key). A result of the deletion operation is a flag indicating whether or not the deletion operation succeeds.

In the deletion operation, the positioning operation is activated with the key as an argument (STEP 7-1), and as the execution result, the “find” flag, the “prev” and the “curr” pointers are received. Next, a value of the “find” flag is examined (STEP 7-2), and when the value is estimated to be “true”, a variable r is set to a value of the reference counter in the “curr” entry (STEP 7-3) and whether or not the value is zero is examined (STEP 7-4).

As a result, when the value of r is a value other than zero, the result of the deletion operation is set as failed (STEP 7-8), and the operation is finished. When the value of r is zero in STEP 7-4, the “atomic cmpxchg” operation is executed, in which the value of the reference counter in the “curr” entry is changed from zero to −1 (STEP 7-5). When the “atomic cmpxchg” operation succeeds, the logical deletion and the physical deletion of the “curr” entry are carried out (STEP 7-6), the deletion operation is set as successful (STEP 7-7), and the reference deletion operation is finished. When the “cmpxchg” operation of STEP 7-5 fails (not shown in FIG. 11), return to STEP 6-3 is performed. When the “find” flag becomes “false” in STEP 7-2, the deletion operation is set as failed (STEP 7-8) and the deletion operation is finished.

According to the present exemplary embodiment, the process of executing the operation of deleting a hash entry from the hash table 71 is a process different from the processes of executing the search and insert operation and the reference deletion process.

The present exemplary embodiment, in which the logical deletion and the physical deletion of a target entry are executed in the deletion operation, is not limited to this method. As a modification example, the deletion operation may only change the reference counter into −1, an operation which performs the logical deletion and the physical deletion of the hash entry in which the reference counter is −1 may be independently provided.

In the present exemplary embodiment, the processing in which the application executes the operation on the hash entry with the search key (key) is the same as the application processing in the first exemplary embodiment, shown in FIG. 7, of the present invention. The processing in which the application deletes the hash entry with the search key (key) only calls the deletion operation with the key as a parameter.

A part or all of the exemplary embodiments may be described as following supplementary notes, which do not limit the present invention to the following. This application claims priority from Japanese Patent Application No. 2012-234776 filed on Oct. 24, 2012, and the contents of which are incorporated herein by reference in their entirety.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

(Supplementary Note 1)

A data storage device, including:

storing means for storing a counter associated with each hash entry in a hash table;

first executing means for, when receiving an execution command for a process, incrementing or decrementing a value of the counter which is associated with the hash entry according to an operation for the hash entry, the operation being included in the process; and

second executing means for, when receiving an execution command for a process including an deletion operation for the hash entry, executing the deletion operation for the hash entry according to the value of the counter which is associated with the hash entry.

(Supplementary Note 2)

The data storage device according to Supplementary Note 1, wherein

when the second executing means receives the execution command for the process including the deletion operation for the hash entry at a specific timing, the process for which the first executing means receives the execution command is other than the process for which the second executing means receives the execution command.

(Supplementary Note 3)

The data storage device according to Supplementary Note 1 or 2, wherein

the process for which the first executing means receives the execution command includes at least two or more different operations in a search operation, an insert operation and the deletion operation of the hash entry.

(Supplementary Note 4)

The data storage device according to Supplementary Note 3, wherein

the first executing means increments the value of the counter when the operation of the hash entry is the search operation and the value of the counter is not a specific value.

(Supplementary Note 5)

The data storage device according to Supplementary Note 3 or 4, wherein

the first executing means decrements the value of the counter when the operation of the hash entry is the deletion operation and the value of the counter is not a specific value.

(Supplementary Note 6)

A data storage method that is executed in a device including a processor and storing means for storing a counter associated with each hash entry in a hash table, the method including:
a first execution step of, when the processor receives an execution command for a process, incrementing or decrementing a value of the counter which is associated with to the hash entry according to an operation of the hash entry, the operation being included in the process; and

a second execution step of, when the processor receives an execution command for a process including an deletion operation for the hash entry, executing the deletion operation for the hash entry according to the value of the counter which is associated with the hash entry.

(Supplementary Note 7)

A program causing a computer to function as:

storing means for storing a counter associated with each hash entry in a hash table;

first executing means for, when an execution command for a process is received, incrementing or decrementing a value of the counter which is associated with the hash entry according to an operation for the hash entry, the operation being included in the process; and

second executing means for, when an execution command for a process including an deletion operation for the hash entry is received, executing the deletion operation for the hash entry according to the value of the counter which is associated with the hash entry.

### INDUSTRIAL APPLICABILITY

The present invention is able to be used, as an application example, a data storage method and a program for data storage, particularly a data storage method and a program for data storage having characteristics that it is possible to execute a search operation, an insert operation, a deletion operation of data by a plurality of threads in parallel and data is not deleted when a thread which uses the data exists.

### REFERENCE SIGNS LIST

1 processor
2 thread
3 program
4 data
5 list
6 array
7 hash table
10 memory
11 processor
21 thread
31 program
41 data
51 list
61 array
71 hash table
100 memory

What is claimed is:

1. A data storage device, comprising:
a storing unit which stores a counter associated with each hash entry in a hash table;
a first executing unit which, when receiving an execution command for a process, increments or decrements a value of the counter which is associated with the hash entry according to an operation for the hash entry, the operation being included in the process; and
a second executing unit which, when receiving an execution command for a process including an deletion operation for the hash entry, executes the deletion operation for the hash entry according to the value of the counter which is associated with the hash entry.

2. The data storage device according to claim 1, wherein
when the second executing unit receives the execution command for the process including the deletion operation for the hash entry at a specific timing, the process for which the first executing unit receives the execution command is other than the process for which the second executing unit receives the execution command.

3. The data storage device according to claim 1, wherein
the process for which the first executing unit receives the execution command includes at least two or more different operations in a search operation, an insert operation and the deletion operation of the hash entry.

4. The data storage device according to claim 3, wherein
the first executing unit increments the value of the counter when the operation of the hash entry is the search operation and the value of the counter is not a specific value.

5. The data storage device according to claim 3, wherein
the first executing unit decrements the value of the counter when the operation of the hash entry is the deletion operation and the value of the counter is not a specific value.

6. A data storage method that is executed in a device including a processor and a storing unit storing a counter associated with each hash entry in a hash table, the method comprising:
a first execution step of, when the processor receives an execution command for a process, incrementing or decrementing a value of the counter which is associated with to the hash entry according to an operation of the hash entry, the operation being included in the process; and
a second execution step of, when the processor receives an execution command for a process including an deletion operation for the hash entry, executing the deletion operation for the hash entry according to the value of the counter which is associated with the hash entry.

7. A non-transitory computer-readable medium storing a program causing a computer to function as
a storing unit which stores a counter associated with each hash entry in a hash table;
a first executing unit which, when an execution command for a process is received, increments or decrements a value of the counter which is associated with the hash entry according to an operation for the hash entry, the operation being included in the process; and
a second executing unit which, when an execution command for a process including an deletion operation for the hash entry is received, executes the deletion operation for the hash entry according to the value of the counter which is associated with the hash entry.
